(19) United States
(12) Patent Application Publication
(10) Pub. No.: US 2007/0011935 A1
(43) Pub. Date: Jan. 18, 2007

(54) Fish stunning device

(76) Inventor: Richard Bass, Queeasland (AU)

Correspondence Address: Rashida A. Karmali, Ph.D, 13th Floor, 99 Wall Street, New York, NY, 10005, US

(21) Appl. No.: 11/524,076

(22) Filed: Sep. 20, 2006

(30) Foreign Application Priority Data
Mar. 22, 2004 (AU) 2004901475

(51) Int. Cl. A01K 79/02

(52) U.S. Cl. 43/17.1

(57) ABSTRACT

A device for stunning fish comprising: an elongate member comprising an open channel through which a fish can pass; a pneumatically operated gun pivotally mounted in said channel, said gun comprising an impact cylinder and piston, wherein said piston is connected to a cylinder striker which is retractably extendable from a sleeve on said cylinder, and wherein said gun can pivot between a lowered firing position where said striker can stun said fish at a set point in a channel and a raised position where said fish can pass beneath said gun; a vertical guide plate pivotally mounted on the internal surface of each wall of said channel and having extended (outward) and retaracted (inward) positions, wherein the end of a guide plate distal the pivotal mounting is at or near said set point and the pivotal mounting is between said set point and the channel entry; a mechanism for pivoting said gun between said lowed and raised positions; a mechanism for pivoting each said guide plate between said extended and retracted positions; a trigger for firing said gun when said lowered position and activating said pivot mechanism to pivot said gun to said raised position, and activating said guide plate pivot mechanism to pivot said plates to said retracted position; and a sensor for detecting passage of said fish out of said channel and activating said pivot mechanism to return said gun to said lowered position, and activating said guide plate pivot mechanism to pivot said plates to said extended position.

### TECHNICAL FIELD

The invention described herein relates to devices and methods for stunning fish. In particular, the invention is directed to a device and method for the automated stunning of fish although the scope of the invention is not necessarily limited thereto.

### BACKGROUND ART

Processing of animals for food usually involves the initial slaughter of the animal. In the processing of larger animals such as cattle, this is typically done by a blow to an animal's head using a pneumatically- or cartridge-powered gun with a captive bolt or piston in place of a projectile.

Processing of some fishes also requires slaughter as an initial step in the process. For example, salmon are typically “stunned” by a blow to the head before processing as food. In many instances, the blow is applied with a simple club, there being no readily available apparatus for the procedure.

Any apparatus must be capable of delivering a blow to the head of fish in such a way that stunning can be done humanely. For most processing needs, the apparatus must also be capable of delivering blows quickly and repetitively so that large numbers of animals or fish can be processed.

Pneumatically powered apparatus are used for larger animals because they meet the needs set out in the previous paragraph However, such apparatus are not suitable for use with smaller animals or fish. Smaller hand-held pneumatic devices are known—for example, pneumatically powered nail guns—but these are not suitable for use as a fish or animal stunning device because of their configurations. Such devices are nevertheless capable of delivering an adequate force.

A pneumatically-powered device suitable for stunning small animals and fish is described in International Application No. PCT/AU01/00745 (Publication No. WO 01/97621) by the present applicant. While this device can be efficiently used for the stunning of large numbers of fish, it has the limitation that it cannot be used in an automatic, flow-through fashion as each fish has to be presented to the device manually.

It is an aim of the invention to provide a stunning device which can be used in an automated-manner or at least provide the consumer with a useful choice.

### SUMMARY OF THE INVENTION

In a broad format, the invention provides a device for stunning fish, the device comprising:

an elongate member comprising an open channel through which a fish can pass;

a pneumatically-operated gun pivotally mounted in said channel, the gun comprising an impact cylinder and piston, wherein the piston is connected to a cylindrical striker which is retractably extendable from a sleeve on said cylinder, and wherein said gun can pivot between a lowered firing position where said striker can stun said fish at a set point in said channel and a raised position where-said fish can pass beneath the gun;

a vertical guide plate pivotally mounted on the internal surface of each wall of the channel and having extended (outward) and retracted (inward) positions, wherein the end of a guide plate distal the pivotal mounting is at or near the set point and the pivotal mounting is between the set point and the channel entry;

a mechanism for pivoting said gun between said lowered and raised positions;

a mechanism for pivoting each said guide plate between said extended and retracted positions;

a trigger for firing said gun when in the lowered position and activating said pivot mechanism to pivot said gun to the raised position, and activating said guide plate pivot mechanism to pivot said plates to the retracted position; and

a sensor for detecting passage of said fish out of said channel and activating said pivot mechanism to return said gun to the lowered position, and activating said guide plate pivot mechanism to pivot said plates to the extended position.

The operating principle of the stunning device according to the invention is similar to that of the WO 01/97621 device in that the fish is killed by a blow to the head administered by the piston of the gun. Activation of the piston results from the head of the fish contacting the trigger. The trigger and cylinder are configured such that when the piston is activated, it strikes the fish just behind and/or between the eyes. This impact is sufficient to kill the fish due to the shock to the brain. However, the device according to the present invention differs substantially from the WO 01/97621 device in that with the former device, the fish passes through the device rather than having to be manually inserted into and withdrawn from the device.

With regard to the components of the device, the channel typically comprises sheets of material forming the walls and floor of the same. Cross-pieces can be provided along the open (top) side of the channel plus strengthening members where device components are mounted to the channel.

The pivoting of the gun is typically effected by providing a mounting for the gun which is connected to the channel at an appropriate point by a shaft which spans the channel walls. The pivot mechanism is advantageously associated with the gun mounting. For example, a crank can be provided on the shaft of the mounting to which crank a pneumatic ram is connected. Any means of pivoting the gun can be employed however.

The trigger typically comprises a contact plate having at least one micro-switch associated therewith. The contact plate is contacted by the nose of the fish when at the set point while the at least one micro-switch activates the gun and the pivot mechanism.

It will be appreciated that guide plates—which, as a consequence of being on opposite sides of the channel, in effect form a chute—aid presentation of the fish to the gun in that they maintain the verticality and centrality of the fish. The mechanism for pivoting the guide plates can be an integral part of, or at least associated with, the gun pivot mechanism, or can be a separate mechanism.

The sensor for detecting passage of the fish out of the channel can be any sensor which will respond to movement of the fish through the sensor point. However, for consistency with other aspects of the devices to be described below, the sensor is advantageously a gate or flap which pivots upwardly when contacted by the fish. This pivoting signals the gun pivot mechanism to return to the lowered (firing) position.

A device according to the invention can also include a lateral and upwardly angled plate which is abutted by the chin of the fish when at the set point. To allow passage of the fish past the set point after firing of the gun, the plate can pivot between raised and lowered positions. In the raised position, the plate supports the chin of the fish while in the lowered position, the plate rests flat against the floor of the channel allowing the fish to be carried on through the channel.

A mechanism is provided for pivoting the chin plate between the raised and lowered positions. Like the guide plate pivot mechanism, the chin plate pivot mechanism can be an integral part of, or at least associated with, the gun pivot mechanism.

The device of the invention can optionally include an entry control module. This module includes an entry sensor that permits only one fish at a time to be at the set point or approaching the set point. The module either has its own channel which is connected to the entry of the device channel or can be mounted into an extended device channel.

The entry control module principally comprises at least one gate or flap pivotally mounted at the top of the channel at or near the mouth thereof. The gate can sense the presence of a fish in the device at or near the set point. On sensing a fish, the gate is locked thereby preventing entry of a further fish. Sensing of the exiting of the fish that has just been stunned results in the unlocking of the entry control module so that the next fish can enter the device and advance to the set point.

The elements and operation of the entry control module will be explained in greater detail below.

It will be appreciated by one of skill in the art that the various mechanisms of a device according to the invention can be operated by any suitable means. Typically however, mechanisms are pneumatically operated in the same manner as the gun. Control of mechanisms is also typically pneumatic.

Other features of a device will be detailed in the following exemplification of a device as will the operation of the device. Briefly however, devices according to the invention can be operated in “hands on” and “hands off” modes. In the former case, an entry control module is not required and an operator merely places fish, individually, into the channel of a device. The operator will of course await the exit of a stunned fish before presenting a further fish to the device.

Inclusion of an entry control module allows operation of a device in a “hands off” manner. However, to facilitate such an automatic operation of the device, a chute is generally provided so that fish are presented to the mouth of the entry control module channel one at a time. Inclusion of an entry control module also ensures that every fish which passes through the device is stunned.

Passage of fish through a device does not require a earner fluid as mucous on the surface of a fish acts as a lubricant. However, a stream of water passing through the device—which may occur during automated operation when a chute supplies fish to the device—does not adversely effect operation of the device provided that the stream does not interfere with sensor function.

Since gravity provides the energy for movement of the fish through the channel, tilting of the channel downwardly from mouth to exit is advantageous. Preferably, the device is tilted at an angle of at least 3°.

Components of the device can be manufactured from any suitable material but are typically manufactured from metals, or plastics where the latter is more appropriate. Preferred metals are stainless steel and brass. Stainless steel components are preferably electro-polished to provide superior corrosion resistance.

Devices according to the invention can be conveniently used with fish of commercial weight such as salmon, trout and sea bass. Devices are most particularly suited for the stunning of salmon during the commercial processing thereof.

With devices according to the invention, fish to be processed can be rapidly and efficiently stunned with minimal risk of injury to an operator since operation of devices can be automated. An additional advantage of devices according to the invention is that the external appearance of the animal or fish is not affected by the killing process. This is particularly important for sale of whole fish. The quality of fish is also enhanced through more rapid and humane killing at the point of harvest.

In order that the invention may be more readily understood and put into practice, one or more preferred embodiments thereof will now be described, by way of example only, with reference to the accompanying drawings.

### BRIEF DESCRIPTION OF THE DRAWINGS

FIG. 1 is a perspective side view of a device according to the invention.

FIG. 2 is a further perspective view of the device shown in FIG. 1 in which the opposite side of the pneumatic gun can be seen including the gun trigger.

FIG. 3 is a perspective view from above of the device of FIG. 1 in which the gun assembly mounting can be seen in greater detail.

FIG. 4 is a perspective view of the device of FIG. 1 from the entry end of the channel in which a guide plate and its pivot mechanism are visible.

FIG. 5 is a further perspective view of the device of FIG. 1 from the entry end of the channel in which a chin plate and its pivot mechanism is visible.

FIG. 6 is a perspective view of the gun trigger.

FIG. 7 is a perspective view of the device exit sensor.

FIG. 8 is a perspective view from above of the entry sensor module.

FIG. 9 is a perspective view of the entry sensor flap control switch activator.

FIG. 10 is a schematic representation of the pneumatic control circuit of the exemplified device.

FIG. 11 is a perspective close-up view of a variant of the device exit sensor showing detail of the sensor valve.

FIG. 12 is a partial perspective view of the exit sensor showing optional components associated with the sensor flap.

For simplicity, air supply lines have been omitted from the drawings showing the device and device components. In drawings showing particular device components other components have been omitted for clarity.

### DETAILED DESCRIPTION OF PREFERRED EMBODIMENTS

The device to be described in the following paragraphs includes the optional entry control module. It will be appreciated however that inclusion of this module is not an essential component of the invention.

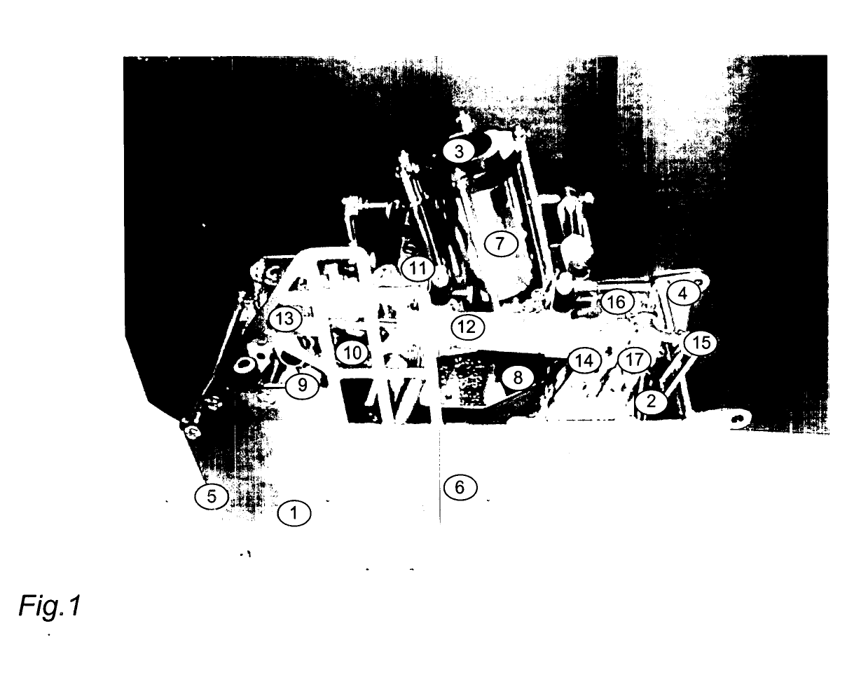

With reference to FIG. 1, there is shown device 1 comprising channel 2, gun assembly 3, and exist sensor 4. An entry sensor module 5, not shown in the drawing but to be described below, is fitted at the mouth of channel 2. Gun 3 is shown in the raised position—that is, post firing. Proximal side wall 6 of channel 2 can be seen in the drawing.

Gun assembly 3 has an impact cylinder 7 and a sleeve 8 from which a striker extends (see below) for stunning a fish on firing. The assembly is pivotally mounted to a shaft 9 across channel 2 by a pair of rails 10 and 11. Pivoting is effected by a double-acting pneumatic ram 12 which is connected between a crank 13 associated with rail 10 and an arm 14 pivotally connected to a plate on side wall 6. The position of arm 14—and hence the position of the gun piston at firing—is set by an adjusting screw 15 between distal end 16 of arm 14 and a fixed member 17 extending upwardly from side wall 6.

The other components of device 1 referred to above will be described in greater detail below.

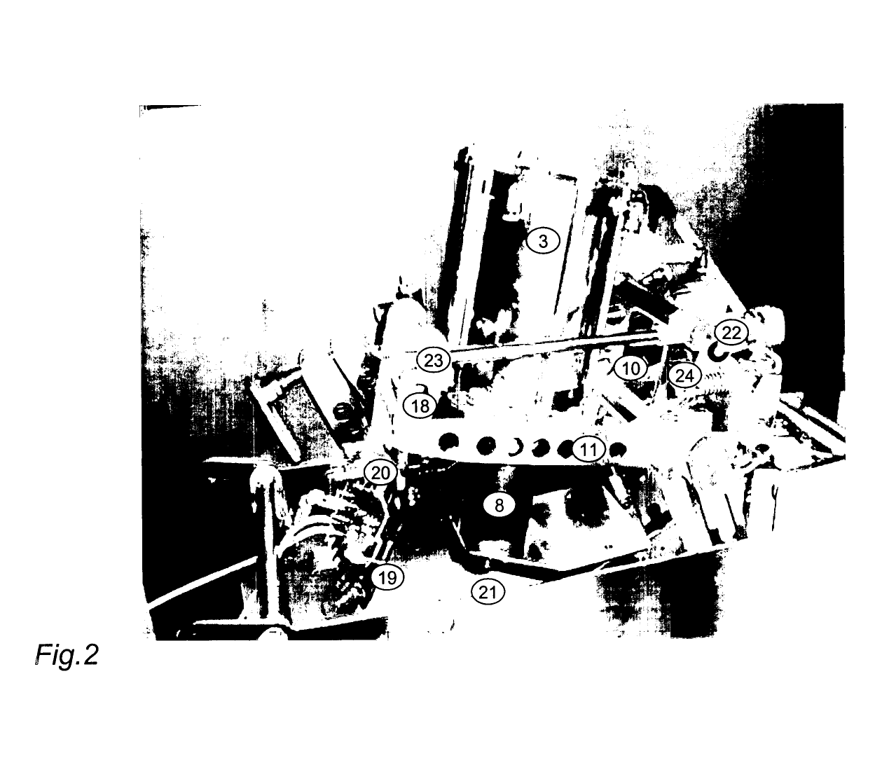

The reverse side of gun assembly 3 as visible in FIG. 1 is shown in FIG. 2. Rails 10 and 11 of the pivotal mounting of the gun can between. A trigger assembly 18 is pivotally mounted to the rails. This assembly includes a contact plate 19 which is pivotal within the assembly and an arm 20 to which trigger valves are mounted. The last mentioned and other components of the trigger will be described below.

Striker 21 can be seen extending from sleeve 8 of gun assembly 3 in FIG. 2. The position of contact plate 19 relative to striker 21 can be set by an adjusting screw 22 between an end 23 of trigger assembly 18 distal the contact plate and an arm 24 on rail 11.

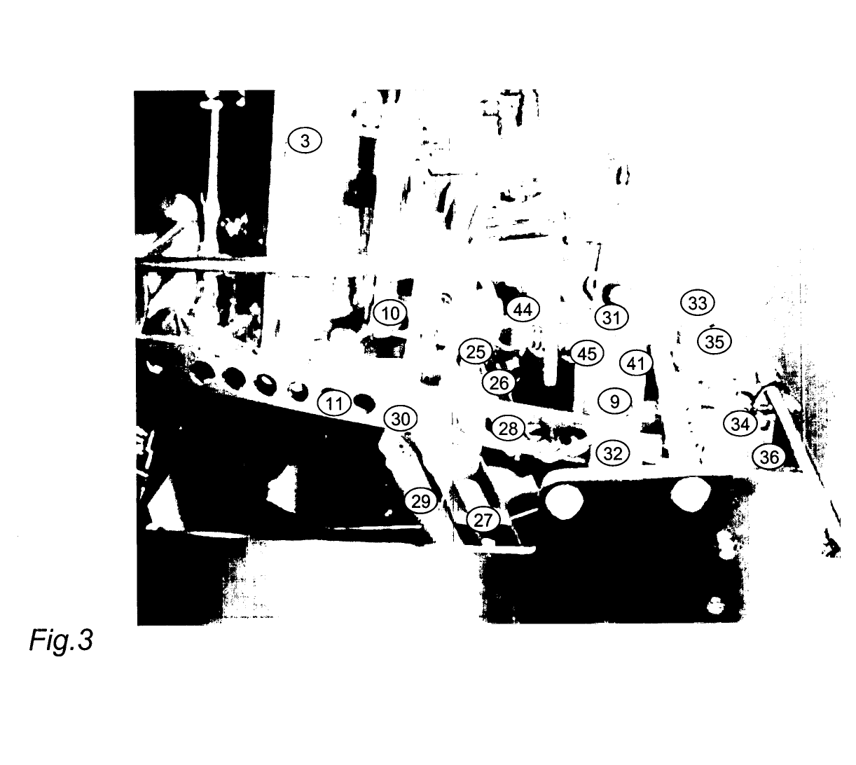

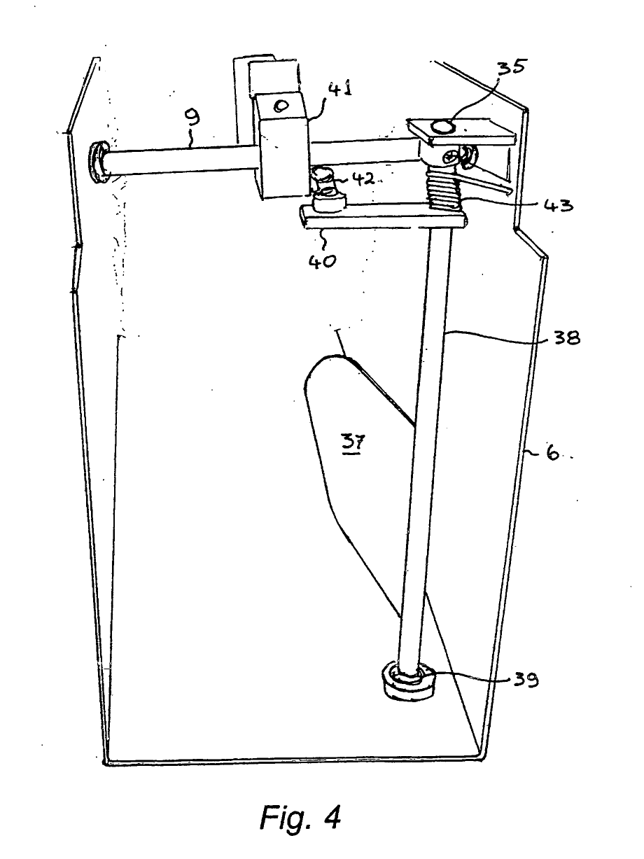

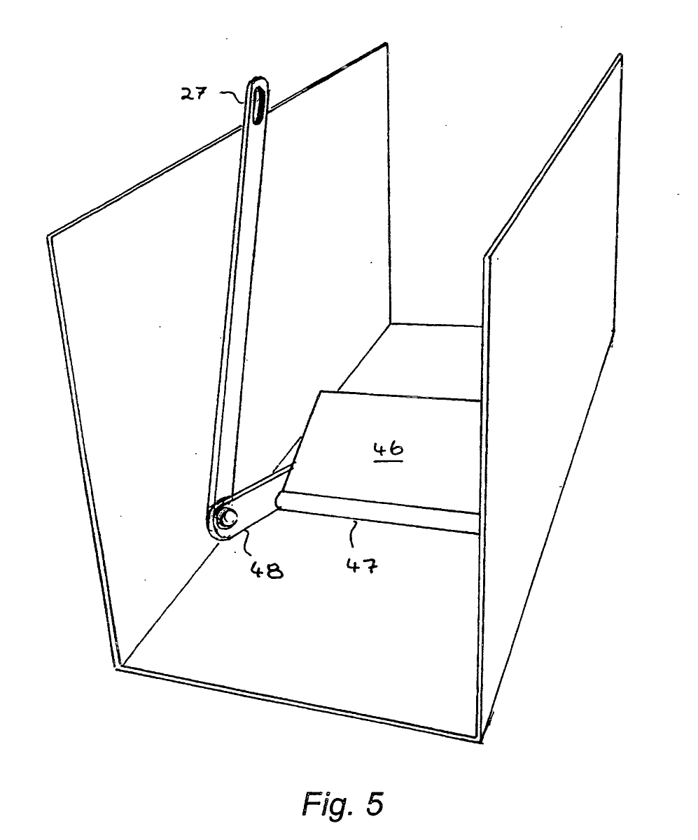

Elements of the device for effecting pivoting of the pair of guide plates (see FIG. 4) and chin plate (see FIG. 5) present in the device can be appreciated from FIG. 3. A shaft 25 is provided across rails 10 and 11. The ends of shaft 25 are located in slots in the ends of links 26 and 27 to the chin plate. (The slots allow for the variable positions of rails 10 and 11 with adjustment of gun assembly 3.) Springs 28 and 29 are connected between a point on links 26 and 27, respectively, to a second shaft 30 spanning rails 10 and 11. These springs bias the chin plate downwards to the ready to fire position and override the play resulting from the slots in the ends of links 26 and 27.

Springs 31 and 32 on shaft 9 counterbalance the weight of gun assembly 3. Ends 33 and 34 of shafts on guide plates within channel 2 (see FIG. 1 and the description of FIG. 4 to follow) are also visible in FIG. 3, these being journalled to bearings 35 and 36 at the top of the channel and bearings in the floor of the channel (not visible in the figure).

One of the guide plates of the pair of plates referred to above is visible in FIG. 4. Guide plate 37 is connected to shaft 38 which is journalled to bearing 35 (see also FIG. 3) and bearing 39. A crank 40 on shaft 38 is pivotally linked to a crank 41 on shaft 9 of the gun assembly pivot (see FIG. 1) by a coupling 42. A spring 43 is also provided to bias guide plate 37 to the outward position. Guide plate 37 when in the inward position, in conjunction with the opposite guide plate, holds the fish upright and centrally as it approaches the gun assembly for firing of the gun.

The operation of a guide plate is as follows. On pivoting upward of the gun assembly after firing; shaft 38 is rotated by the linkage to the gun assembly via coupling 42 and cranks 40 and 41. The rotation of shaft 38 thus also rotates guide plate 37 until it lies close to parallel with side wall 6 of the channel of the device. Pivoting of the gun assembly to the lowered (firing) position forces the guide plate to return to its inward position. The guide plate opposite to guide plate 37 operates in an identical manner. Adjustment of the distance between the ends of the guide plates distal their shafts is effected by a screw 44 which sets the position of crank 41 on shaft 9 (see FIG. 3). Such adjustment is necessary to accommodate fish of different widths. Crank 41 can actually freely rotate on shaft 9. Co-rotation of crank 41 with shaft 9 is effected by a fixed member 45 on the shaft which contacts the crank through adjustment screw 44. As a result of this the guide plates always open to be parallel to the sides of the channel but without restricting the upward pivoting of gun assembly 3.

A chin plate 46 is shown in FIG. 5. Chin plate 46 is connected to a shaft 47 journalled to bearings not shown in the drawing in the side walls of the channel. A crank extends away from each end of the shaft, one of which cranks is item 48. Crank 48 is pivotally connected to an end of link 27 (see FIG. 3).

On upward rotation of the gun assembly, it will be appreciated that chin plate 46 is rotated because of the action of link 27 on crank 48. This causes the chin plate to lie essentially flat against the floor aiding passage of a fish beyond the set point after firing of the gun. As noted above, the slots in the links compensate for the different position of shaft 25 (see FIG. 3) relative to chin plate 46 with adjustment of the position of gun assembly 3.

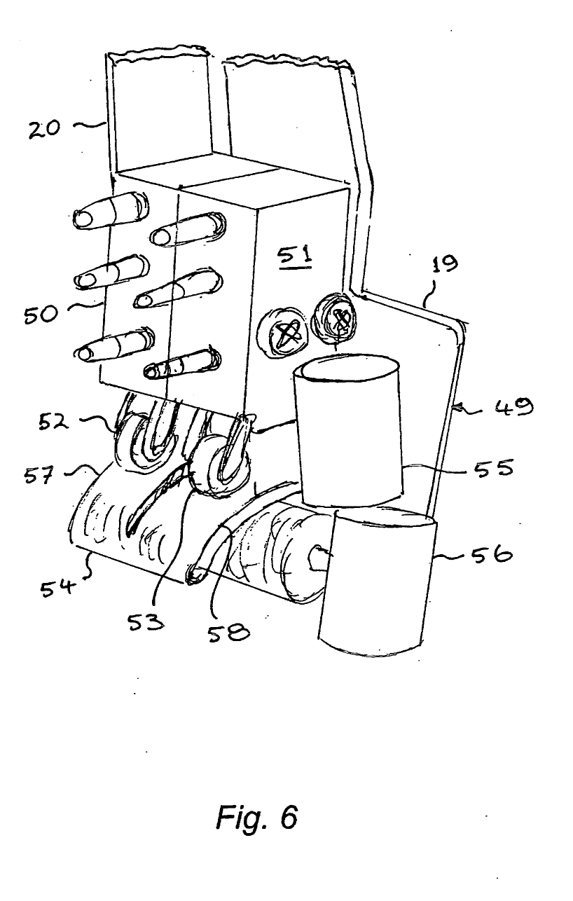

With reference to FIG. 6, there is shown portion 49 of trigger assembly 18 included in FIG. 2. In portion 49, contact plate 19 and arm 20 can be seen. A normally open valve 50 and normally closed valve 51 are mounted to arm 20. The rollers 52 and 53 of valves 50 and 51, respectively, are acted on by a ramp 54 which extends from contact plate 19. The trigger is in fact shown in the “fired” configuration. That is, contact plate 19 has been pivoted towards the rest of the assembly such that ramp 54 engages rollers 52 and 53 thus actuating valves 50 and 51. Contact plate 19—and hence also ramp 54—is held in the fired position by an over-centre magnetic “spring”, the components of which are items 55 and 56. This spring conversely holds the trigger in a cocked position when the device is reset to a “ready to fire status” (see below). Since spring 55/56 holds contact plate 19 in a fired position once firing has occurred, multiple firing is not possible. The trigger is thus a “dead trigger” which has to be reset.

Ramp 54 can be seen to be bilateral. The portion 57 of the ramp that contacts roller 52 of valve 50 is steeper than the portion 58 that contacts roller 53 of valve 51. Consequently, valve 50 is activated before valve 51. Conversely, there is delayed activation of valve 51, albeit by milliseconds. The function of the delayed actuation of valve 51 will be explained below.

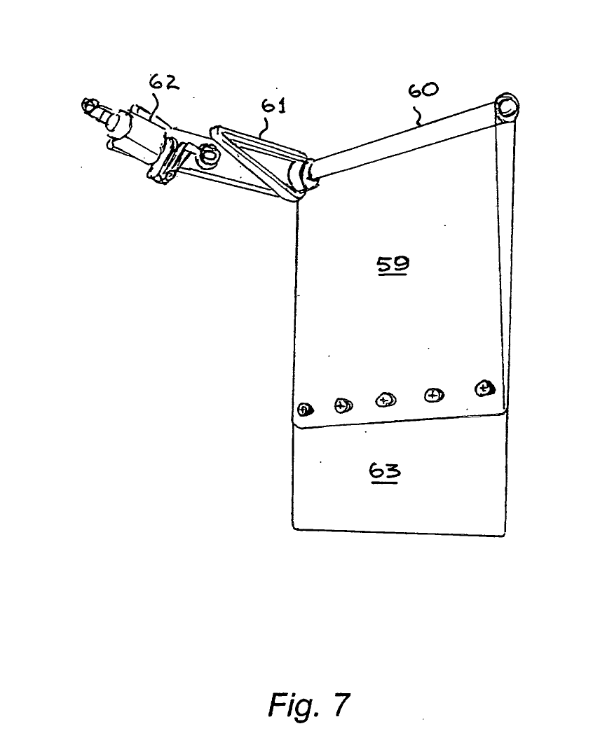

FIG. 7 shows the exit sensor 4 of device 1 of FIG. 1. This comprises a flap 59 on a shaft 60 the ends of which are journalled into bearings on the side walls of channel 2 of device 1 (see FIG. 1). An arm 61 extends inwardly of shaft 60 and is positioned so that its end can contact the roller of roller lever valve with idle return 62. Valve 62 is orientated so that actuation only occurs (momentarily) on return of flap 59 to its normal position after the fish has completely exited the device. That is, the valve is not actuated when arm 61 contacts the valve during the rotation caused by the fish passing under the exit sensor and is only momentarily actuated on return of flap 59 to its rest position.

To allow for variable resetting of the device after firing of gun assembly 3, the angle between arm 61 and flap 59 is adjustable. The lower portion 63 of flap 59 can comprise a removable section to adjust the sensor for fish of different heights.

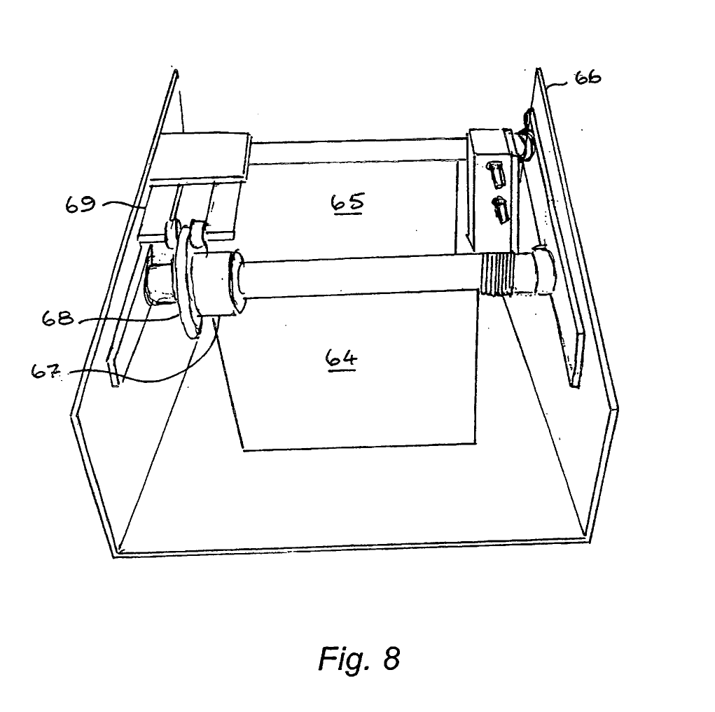

The entry control module 5 referred to above in connection with FIG. 1 is shown in detail in FIG. 8. The module comprises a first flap 64 and a second flap 65, both of which are pivotally mounted across the top of the channel 66 which comprises the module. Both flaps can be independently pivoted and are biased towards rest positions in which the flaps are vertical.

Flap 64 has associated therewith a cam clutch 67 which incorporates a disk 68. There is a caliper 69 included in the module which when activated acts on the disk to brake the cam clutch. When braked, cam clutch 67 prevents pivoting of flap 64 inwardly although it can still return to its rest position. A pneumatic cylinder under constant pressure can optionally be linked to gate 64 to aid return of the gate to its rest position.

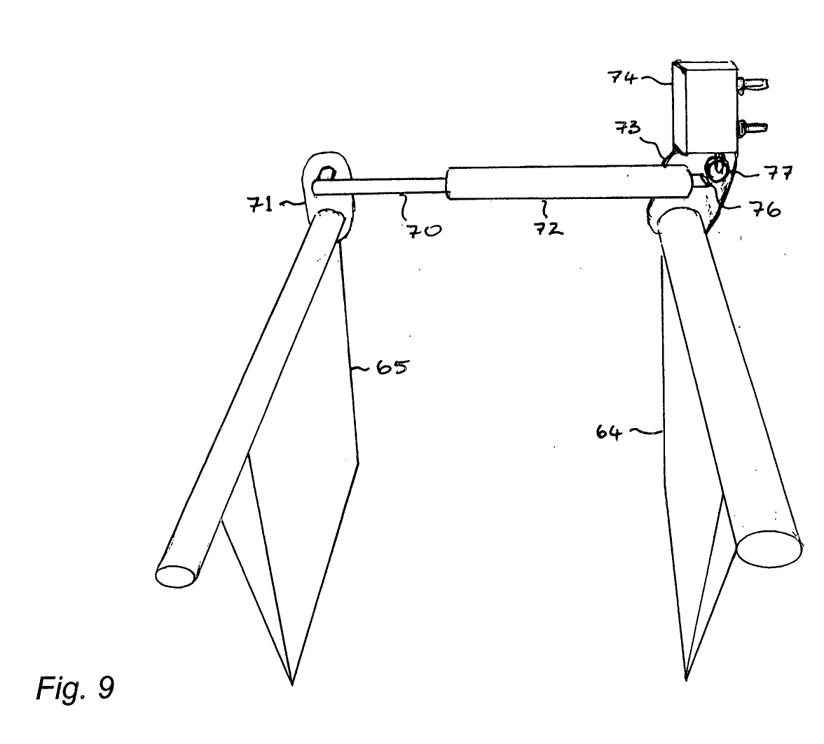

Braking is controlled by a mechanism depicted in FIG. 9. In this figure, cam clutch 67 of FIG. 8 has been omitted for clarity. A rod 70 extends from a pivotal connection on a crank 71 on flap 65 through a supporting sleeve 72. Supporting sleeve 72 is fixed at the end distal flap 65 to a plate 73 which carries a normally closed roller valve 74. Plate 73 is pivotally connected to a crank 75 on flap 64. The free end 76 of rod 70 is beveled and with both flaps 64 and 65 in their rest (vertical) positions is near roller 77 of valve 74 but not in contact therewith. However, extension of rod 70 causes beveled end 76 to contact roller 77 thereby actuating valve 74. Actuation of valve 74 can only occur when flap 65 has been rotated inwards to a-greater degree than flap 64.

Flap 57 of exit sensor 4 and flaps 64 and 65 of entry control module 4 typically comprise a sheet of stainless steel. Rather than comprising a sheet, any one of these flaps can comprise a plurality of cross-pieces or a panel of mesh material or a grille fixed between a frame. Such a flap is not affected by a flow of water through the device.

The device components described above are controlled and operated pneumatically. Device 1 thus includes a regulator for supplying air to the various components of the device at a suitable pressure (typically 400 to 700 kPa).

The channel of the device is typically covered when in use to prevent operator injury through contacting the moving parts of the device. The cover is advantageously pivotally mounted to the channel and includes a safety lock which shuts off air supply to the device but fires gun assembly 3 when the cover is lifted.

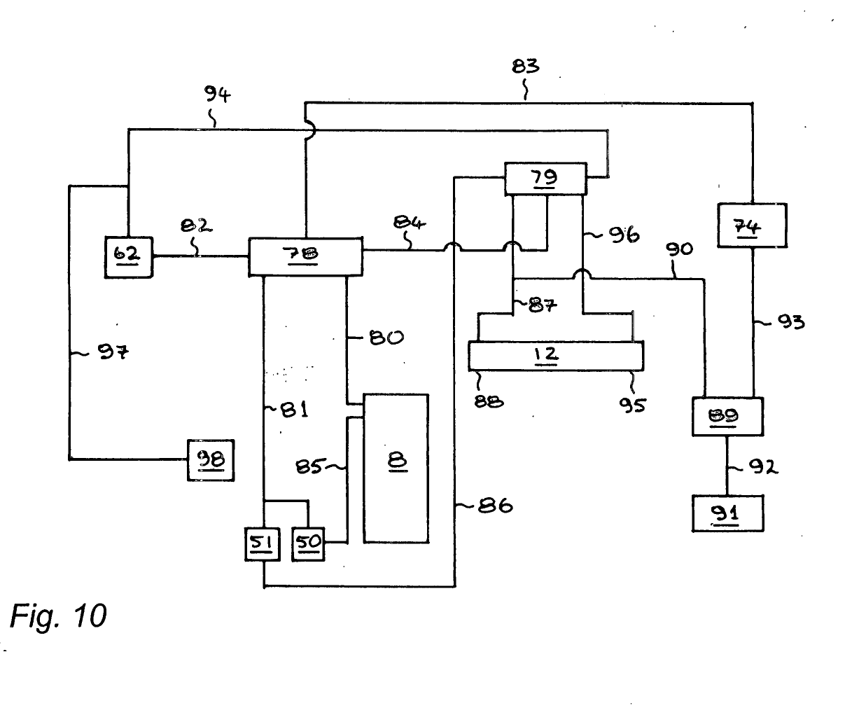

The pneumatic control circuitry of the device is depicted in FIG. 10. The circuitry comprises an air supply 78 which supplies air to impact cylinder 8, valves 50 and 51 of trigger assembly 18, valve 62 of exit sensor 4, valve 74 of entry control module 5, and five-way memory valve 79. These components are supplied by lines 80 to 84, respectively. Actuation of valves 50 and 51 through movement of contact plate 19 of trigger 18 closes of air flow to impact cylinder 8 but allows air to flow to memory valve 79 via lines 85 and 86, respectively. The stoppage of air to impact cylinder 8 fires the gun while the supply of air to memory valve 79 sets the valve so that air can flow via line 87 to the end 88 of ram 12 to effect pivoting of gun assembly 3 (FIG. 1) to the raised position. Air can also flow to OR valve 89 via line 90 to actuate brake cylinder 91 via line 92 which operates brake caliper 69 of the entry sensor module 5 (see FIG. 10). Air can also flow to OR valve 89 via line 93 when valve 74 is open.

On exiting of a fish, valve 62 is actuated causing a pulse of air to be directed via line 94 to the side of memory valve 79 opposite the side to which air is supplied by line 86. This causes a resetting of the memory valve so that air is directed to end 95 of ram 12 via line 96. This results in a reversal of ram 12 action which pivoted gun assembly 3 into the raised position so that the assembly returns to the lowered (firing) position. The actuation of valve 62 also allows a pulse of air to flow via line 97 to single acting pneumatic ram 98 which resets contact plate 19 of trigger assembly 18 (see FIGS. 2 and 6). When contact plate 19 is reset, valve 50 causes air to flow to impact cylinder 8 which causes striker 21 to retract into sleeve 8 and the gun to be recharged.

It will be appreciated from the above by a person skilled in the art that OR valve 89 allows supply of air to the brake cylinder via two paths. Consequently, closure of valve 74 alone will not allow release of the brake. Such release can only occur when exiting of the stunned fish has been detected by exit sensor 4. This detection results in shut-off of the air supply to the OR valve via line 90.

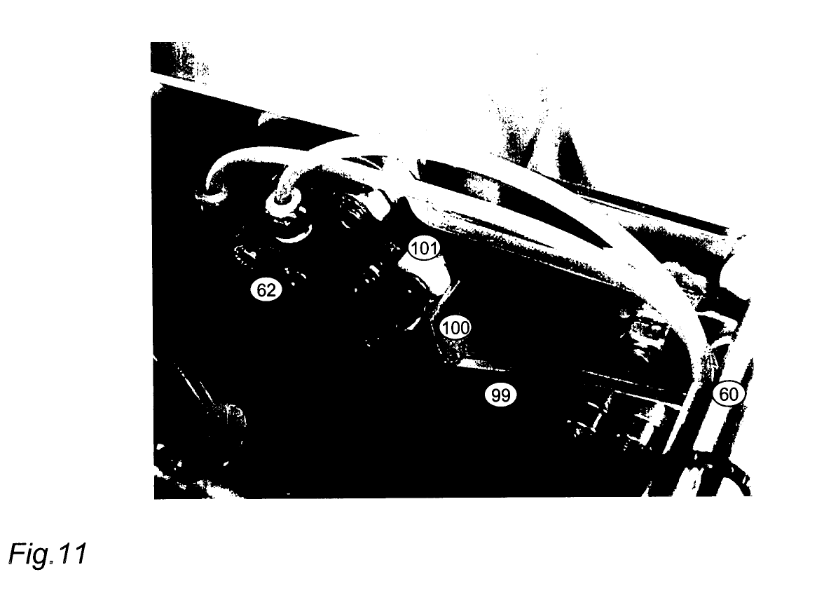

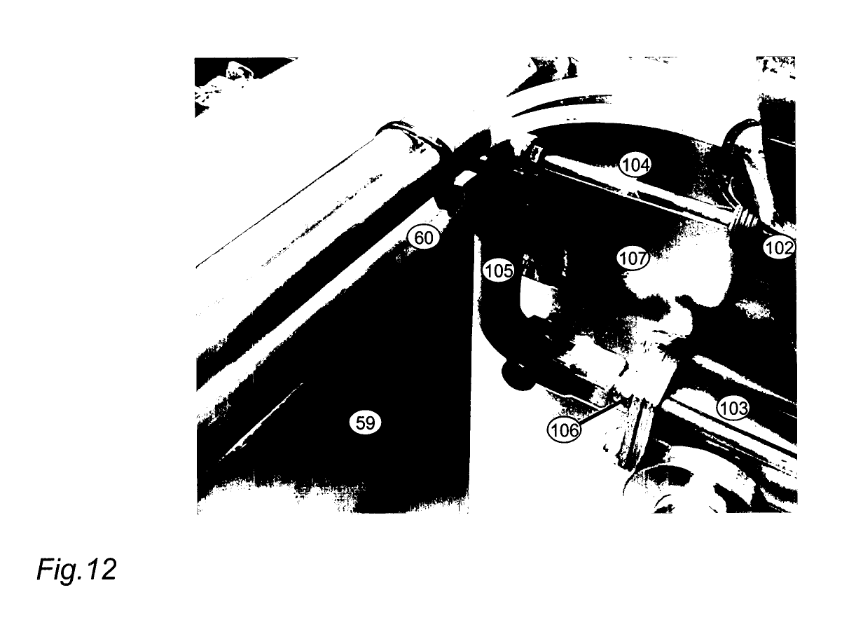

A variant of the exit sensor 4 (see FIG. 1) is depicted in FIGS. 11 and 12. In the former figure, valve 62 can be seen as well as an arm 99 extending from shaft 60. Arm 99 has at its distal end a plate 100 which gives a longer signal on contacting roller 101 of valve 62. Valve 62 is rotated relative to its position in FIG. 7 to allow the correct geometry with regard to contact plate 100.

To give more positive control over the return of flap 59 (see FIG. 7) of exit sensor 4 to its rest position, a pneumatic cylinder under constant pressure (to act as a spring) and a one-way damper can be linked to the flap. These items are shown (in part) as items 102 and 103, respectively, of FIG. 12. Cylinder 102 has a rod 104 (which is connected to a piston within the cylinder) extending therefrom linked to shaft 60 of flap 59. On opening of gate 59, rod 102 is forced into cylinder 102, the pressure therein forcing the rod in the opposite direction to rotate flap 59 to the vertical rest position. It will be appreciated that the force exerted by cylinder 102 is at a maximum when the flap is in the vertical rest position and at a minimum when the flap is fully open. This is the opposite of the force of gravity on the flap.

The one-way damper 103 of FIG. 12 is linked to shaft 60 by crank 105. On opening of gate 59, rod 106 (which is connected to a piston within the damper) is drawn out of the damper. On return of the flap to its vertical rest position, further rotation beyond that position is resisted by the damper. The presence of the damper also prevents oscillation of the gate about the vertical rest position on return thereto. In addition to flap 59, a portion of side wall 107 of device 1 (FIG. 1) can be seen in FIG. 12.

The operation of the device is described in the following paragraphs.
a) Prior to admission of a fish, gun assembly 3 is in the lowered (firing) position and trigger assembly 18 is armed. That is, contact plate 19 is pivoted away from valves 50 and 51 so that ramp 54 is not in contact with the rollers of the valves. Flap 59 of exit sensor 5 is in the rest position as are flaps 64 and 65 of entry control module 5. The guide plates (see, for example, item 37 of FIG. 4) and chin plate 46 are in the inward and raised positions, respectively.
b) On entering the device, a fish advances to the set point which is where the nose of the fish meets contact plate 19 of trigger assembly 18. Pivoting of the contact plate actuates valves 50 and 51 which results in:
   i) firing of impact cylinder 8 so that striker 21 stuns the fish;
   ii) resetting of memory valve 79 with actuation of ram 12 and hence pivoting of gun assembly 3; and
   iii) coincidentally with the pivoting of gun assembly 3, pivoting of the guide plates to their open positions (essentially parallel with the channel walls) and the lowering of the chin plate).
c) A fish at the set point is detected by entry control module 5 which locks flap 64 and prevents entry of a further fish.
d) Passage of the stunned fish past the set point (possible because of the pivoting of gun assembly 3 to the raised position, and the coincidental pivoting of the guide and chin plates) and out of the device is detected by exit sensor 4 which results in:
   i) resetting of memory valve 79 with actuation of ram 12 and hence pivoting of gun assembly 3 to the lowered (firing) position;
   ii) coincidentally with the pivoting of gun assembly 3, pivoting of the guide plates to their inward positions and the raising of the chin plate;
   iii) actuation of ram 98 and hence rearming of trigger assembly 18;
   iv) recharging of impact cylinder 8; and
   v) shut-off of air to brake cylinder 92 which releases the brake on flap 64 so that another fish can enter the device.

It will be appreciated that steps (a) to (d) represent a complete cycle which is repeated for the stunning of further fish.

The foregoing embodiments are illustrative only of the principles of the invention, and various modifications and changes will readily occur to those skilled in the art. The invention is capable of being practiced and carried out in various ways and in other embodiments. It is also to be understood that the terminology employed herein is for the purpose of description and should not be regarded as limiting.

The term “comprise” and variants of the term such as “comprises” or “comprising” are used herein to denote the inclusion of a stated integer or stated integers but not to exclude any other integer or any other integers, unless in the context or usage an exclusive interpretation of the term is required.

Any reference to publications cited in this specification is not an admission that the disclosures constitute common general knowledge in Australia.

1. A device for stunning fish, the device comprising:
an elongate member comprising an open channel through which a fish can pass;
a pneumatically-operated gun pivotally mounted in said channel, the gun comprising an impact cylinder and piston, wherein the piston is connected to a cylindrical striker which is retractably extendable from a sleeve on said cylinder, and wherein said gun can pivot between a lowered firing position where said striker can stun said fish at a set point in said channel and a raised position where said fish can pass beneath the gun;
a vertical guide plate pivotally mounted on the internal surface of each wall of the channel and having extended (outward) and retracted (inward) positions, wherein the end of a guide plate distal the pivotal mounting is at or near the set point and the pivotal mounting is between the set point and the channel entry;
a mechanism for pivoting said gun between said lowered and raised positions;
a mechanism for pivoting each said guide plate between said extended and retracted positions;
a trigger for firing said gun when in the lowered position and activating said pivot mechanism to pivot said gun to the raised position, and activating said guide plate pivot mechanism to pivot said plates to the retracted position; and
a sensor for detecting passage of said fish out of said channel and activating said pivot mechanism to return said gun to the lowered position, and activating said guide plate pivot mechanism to pivot said plates to the extended position.

2. The device according to claim 1, wherein said channel comprises sheets of material forming the walls and floor of the channel.

3. The device according to claim 1, wherein cross-pieces are provided along the open (top) side of said channel.

4. The device according to claim 1, wherein the pivoting of the gun is effected by providing a mounting for the gun which is connected to the channel by a shaft which spans the channel walls.

5. The device according to claim 4, wherein said pivot mechanism comprises a crank on said shaft of the mounting to which crank a pneumatic ram is connected.

6. The device according to claim 1 wherein said trigger comprises a contact plate having at least one micro-switch associated therewith.

7. The device according to claim 1, wherein said exit sensor comprises a gate or flap which pivots upwardly when contacted by a fish.

8. The device according to claim 7, wherein said exit sensor gate or flap has associated therewith a mechanism for returning said gate or flap to its vertical rest position.

9. The device according to claim 8, wherein said mechanism for returning said gate or flap to its vertical rest position comprises a pneumatic cylinder.

10. The device according to claim 7, wherein said exit sensor gate or flap has associated therewith a damper for retaining said gate or flap in its vertical rest position.

11. The device according to claim 1 further comprising a lateral and upwardly angled plate which is abutted by the chin of the fish when at the set point which plate can pivot between raised and lowered positions.

12. The device according to claim 11 wherein a mechanism is provided for pivoting said chin plate pivot mechanism can be an integral part of or at least associated with, the gun pivot mechanism.

13. The device according to claim 12, wherein said chin plate pivot mechanism is an integral part of, or at least associated with, the gun pivot mechanism.

14. The device according to claim 1 further comprising an entry control module which permits only one fish at a time to be at the set point or approaching the set point.

15. The device according to claim 14, wherein said entry control module is mounted in a channel which is connected to the entry of the device channel or is mounted in an extended device channel.

16. The device according to claim 15, wherein said entry control module comprising at least one gate or flap pivotally mounted at the top of the device or module channel at or near the mouth thereof.

17. The device according to claim 16, wherein said entry control module comprising two interconnected gates or flaps.

18. The device according to claim 16, wherein said entry control module includes a braking mechanism for controlling the opening of the at least one gate or flap.

19. The device according to claim 1, comprising a pneumatic circuitry for controlling gun firing and pivoting.

20. The device according to claim 16, wherein said channel inlet has a chute associated therewith for delivery of fish into the device.

21. A method of stunning fish comprising allowing a fish to pass through a device according to claim 1.

22. The method according to claim 21, wherein said device is angled downwardly at up to aid passage of fish through the device.
